(19) United States
(12) Patent Application Publication
(10) Pub. No.: US 2010/0230210 A1
(43) Pub. Date: Sep. 16, 2010

(54) RETRACTING PLATFORM

(76) Inventors: Gilbert A. Hanks, Fleming Island, FL (US); Christopher Hanks, Fleming Island, FL (US)

Correspondence Address: Wood, Atter & Associates, P.A., 333-1 East Monroe Street, Jacksonville, FL, 32202, US

(21) Appl. No.: 12/403,230

(22) Filed: Mar. 12, 2009

(51) Int. Cl. E04G 5/14; B60P 1/64

(52) U.S. Cl. 182/113; 414/498

(57) ABSTRACT

A retracting platform assembly for motor vehicle carrier trucks, where the platform retracts to a vertical position. The railing system remains in a vertical position, extending and retracting along a horizontal plane, and provides additional protection from falling off the edge of the platform. A series of elevation rods between the platform grate and the railing system aids in the transition between the extended and retracted positions. A weight-bearing beam assists in supporting the weight of the platform assembly, as well as attaches to a power supply that pushes and pulls the platform assembly from one position to the other.

### CROSS-REFERENCE TO RELATED APPLICATIONS

Not applicable.

### FEDERALLY SPONSORED RESEARCH

Not applicable.

### SEQUENCE LISTING OR PROGRAM

Not applicable.

### FIELD OF THE INVENTION

This invention generally relates to platforms. Specifically, this invention relates to retracting platforms, particularly for use on motor vehicle earner tracks.

### BACKGROUND OF THE INVENTION

Motor vehicle carrier trucks are designed to transport passenger vehicles, such as sedans, vans, pick-up trucks, and sport utility vehicles. These carrier trucks are typically capable of loading several vehicles into a bottom deck and a top deck. While the bottom deck may only be a few feet from the ground, the top deck is much higher, usually elevated eight or more feet above the ground. The decks upon which these vehicles are loaded, especially the top deck, are sometimes no more than two tire-wide runners, each spaced apart in such a fashion that the runners line up with the left-side and right-side tires of a standard passenger vehicle.

In the carrier truck industry, it is standard practice to load these vehicles onto the earner track deck by having a person enter the vehicle to be loaded, and physically drive the vehicle onto the decks by lining up the vehicle tires with the runners. A problem then arises once the vehicle has been loaded on the carrier truck: the person must then exit the vehicle, and negotiate a descent from the carrier truck. When the deck is made up only of the runners, the narrow and often slippery runners are the only footing, and any other part of the frame of the carrier truck is used for hand grips. This poses a substantial hazard to this person's safety, since the runners are not designed for foot travel, and the carrier truck frame is not designed to allow for secure gripping or to anchor safety equipment, such as a harness, to prevent someone from failing. As such, people negotiating the descent from the earner truck are at risk of losing their footing or their grip. Slips or falls from the bottom and top decks of these earner trucks can result in serious or fatal injuries.

The width of these carrier trucks and the decks they haul are restricted by the width of the highways and streets upon which they travel. These roadways are only wide enough to accommodate a standard passenger vehicle as it travels in its ordinary course along that road. For an ordinary passenger vehicle, these roads may offer ample room to comfortably drive within a lane of travel. However, there is significantly less room for the carrier truck, since the roadway must now accommodate not only the width of the passenger vehicle, but also the runners upon which they rest, and the frame of the carrier truck itself. Due to width restrictions of the roadways, it is imperative that any additions to the body of these carrier trucks, such as platforms, mirrors, and lights, add only minimally, if at all, to the overall width of the carrier truck. Furthermore, the width of a carrier truck is restricted by government agencies, such as a state's Department of Transportation.

Despite the inefficiency and obvious safety deficiencies of commonly used procedures for dismounting a carrier truck after loading a vehicle, the Applicants have found no prior art devices that are designed to address these shortcomings. However, the collapsing platforms are known in the prior art. Specifically, retracting platforms previously devised and utilized are known to consist basically of familiar, expected, or obvious structural configurations.

By way of example, the prior art discloses a safety platform for sanding trucks in U.S. Pat. No. 4,613,155 to Greenwood; a pipeline construction safety platform in U.S. Pat. No. 6,830,127 to Johnson; and a vehicle step device in U.S. Pat. No. 6,880,843 to Greer, Jr.

In this respect, the retracting platform for motor vehicle carrier trucks, according to the present invention, substantially departs from the conventional concepts and designs of the prior art, and in so doing, provides an apparatus primarily developed for the purpose of providing a retracting platform that, while adding little, if any width to the carrier truck in the platform's retracted state, such platform allows for safe foot travel. The present invention also provides for a railing system integrated into such platform, and an access panel through the platform for dismounting the carrier truck.

Therefore, it can be appreciated that there exists a need for a new and improved retracting platform, which can be used for vehicle carrier trucks. In this regard, the present invention substantially fulfills this need.

### SUMMARY OF THE INVENTION

Accordingly, the present invention is a retracting platform for motor vehicle carrier tracks. Integrated into the platform is a grate, a railing system, an access panel, and an support beam to transfer the kinetic energy from a power source, like that provided by a hydraulics system, to retract and extend the platform. Personnel safety, efficiency, and cost-effectiveness are always goals in the motor vehicle carrier industry, and the present invention offers a unique tool to achieve those goals.

Although platforms have been provided for vehicles, even including platforms which have integrated a railing system or platforms that are collapsible, there is no known mechanism which can be simply and economically adapted for the above-mentioned carrier trucks without the addition of relatively complicated mechanisms.

In general, the platform is anchored to the truck frame. The frame may be the two tire-wide runners upon which the cargo rests, a deck, or the body of the carrier truck itself. The platform in its extended position is a substantially horizontal grate. This grate is to be constructed of a material lightweight enough so as to facilitate the transition to its substantially vertical, retracted position. Furthermore, the material must be sufficiently lightweight, as to minimize its overall contribution to the overall weight of the earner truck, yet the grate must also be durable enough to bear the weight of at least one adult over many years of use.

The grate rests on elevation rods which are hingedly attached to the truck frame. These rods, in turn, rest on extension bars. Preferably, these rods are tapered at their distal ends. This facilitates a smoother transition between grate positions, and allows the grate to lie in a more horizontal position when extended. In the preferred embodiment, the bars are telescoping, enabling them to elongate and shorten, as needed. There are two extension bars; the bars are pivotally joined together at one end, and pivotally joined to the frame of the carrier truck at the other distal end. A hydraulic piston is attached to a beam supporting the weight of the platform. This support beam is connected to the extension bars where they are pivotally joined to each other. The hydraulic piston is part of the carrier truck's hydraulics system, a system exploiting pressurized fluids that is well known in the prior art and used as part of the standard equipment in the industry.

In the retracted position, the extension bars are parallel to each other, and are essentially flush with the frame of the carrier truck. Upon activation of the hydraulics system, the hydraulic piston pushes outward on the support beam, which in turn pushes outward on the bars. The bars then extend in length. As the bars are pushed outward, the elevation rods in the preferred embodiment are lowered from their substantially vertical position, as they slide down the shaft of the extension bars. As the rods are lowered, so is the grate resting upon them.

A railing system is also integrated into the platform. The railing system is comprised of a set of stanchions, each stanchion connected to its adjacent counterpart by a series of cables, chains, or other barrier means along the outer edge of the platform. In the preferred embodiment, the cables connecting its respective stanchions must be taut when the platform is in its fully extended position. The cables will slacken when the platform is retracted, because the extension bars will have shortened in length. In any event, the barrier along the outer edge of the platform must accommodate the changing length of the extension bars, upon which the stanchions are anchored.

In addition to the railing system, the platform also features an access panel. The panel in the preferred embodiment is located in the center of the grate, but can be located anywhere on the grate. The panel must also be able to bear the weight of an adult standing or walking on it. When the platform is in its extended position, the panel is in the same plane as the grate. The panel can then be swung open to a substantially vertical position, permitting an individual to pass through the grate. This panel becomes useful when it is lined up with a means of descending the decks of the carrier truck, such as a ladder.

Thus, the general features of the invention have been broadly outlined, such that the detailed description thereof that follows may be better understood. There are, of course, additional features of the invention that will be described, which will form the subject matter of the claims. The claims should be regarded as providing the limits of the present invention. It is to be noted that the invention is not limited to the details of construction, or to the arrangements of the elements set forth in the following description or representations in the figures. The invention is capable of other embodiments and of being used in a variety of ways for a multitude of purposes. Also, it is to be understood that the phraseology and terminology employed herein are for the purpose of description, and should not be regarded as limiting.

It is thus an object of this present invention to provide a platform allowing for safe foot travel. It is another object of this invention to provide a railing system that can be easily gripped, or that can accommodate safety equipment to prevent falls. It is yet another object of this invention to allow access to a means, such as a ladder, to safely descend from the top deck of a carrier truck.

Due to various limitations on a carrier truck's width imposed by governing agencies or by industry standards, it is therefore another object of the present invention to provide a platform that is large enough to sufficiently accommodate a person exiting a vehicle loaded on the carrier truck. Concurrently, it is an object of the invention to provide for a platform that can retract, so that when it is not in use, the retracted platform has little, if any, effect on the width of the carrier truck.

It is another object of the present invention to provide a new and improved retracting platform, which provides advantages over the prior art, while simultaneously overcoming the disadvantages of the prior art.

It is another object of the present invention to provide a new and improved retracting platform, which may be easily and efficiently manufactured and marketed.

It is a further object of the present invention to provide a new and improved retracting platform, which is durable and reliable in design and structure. At the same time, it is yet another object to provide an esthetically pleasing retracting platform.

An additional object of the present invention is to provide a new and improved retracting platform, which provides a simple, easy-to-operate apparatus.

Yet another object of the present invention is to provide a new and improved retracting platform, wherein, considering the cost of materials and labor, manufacture of the invention provides an economic advantage. Such an advantage can be passed to the consumer, thus making the invention more accessible to the public.

Still another object of the present invention is to provide a safety measure for persons who are maneuvering about or dismounting the decks of a motor vehicle carrier track.

These, together with other objects of the invention, along with the various features of novelty which characterize the invention, are pointed out with particularity in the claims, which are a part of this disclosure. For a better understanding of the invention, its operating advantages and the specific objects attained by its uses, reference should be made to the accompanying description and FIGS., in which there are illustrated preferred embodiments of the invention.

Further objects and advantages of this invention will become apparent from a consideration of the drawings and ensuing description.

While the above description contains many specificities, these should not be construed as limitations on the scope of the invention, but as exemplifications of the presently preferred embodiments thereof. Thus, the scope of the invention should be determined by the appended claims and their legal equivalents, and not by the examples given. Many other ramifications and variations are possible within the teachings of the invention. For example, the retracting platform can be used on transportation means other than motor vehicle carrier trucks, such as trains or water craft, or on fixed structures like buildings, piers, or loading docks.

In view of the foregoing disadvantages inherent in the known types of platforms present in the prior art, the present invention provides an improved platform for motor vehicle carrier trucks. As such, the general purpose of the present invention, which will be described in greater detail, is to provide a new and improved retracting platform, which has all the advantages of the prior art, and none of the disadvantages.

### DRAWINGS—FIGURES

The features and advantages of the present invention will be better understood and objects other than those set forth will become apparent when consideration is given to the following detailed description thereof. Such description makes reference to the annexed drawings wherein:

FIG, 1 is a view from below the retracting platform, showing the platform in its fully extended position, and the access panel in the closed position.

FIG. 2 is another view from below the retracting platform, where the 2′ arrow indicates the direction of extension of the hydraulic piston, which then extends the platform, and the 2″ arrow indicates the direction of movement to close the access panel.

FIG. 3 is another view from below the retracting platform, where the 3′ arrow indicates the direction of retraction of the hydraulic piston, which then retracts the platform. As a result of the retraction, the extension bars shorten in a telescoping manner, in a manner indicated by the 3″ arrows, and the cables, chains, or other barrier means along the outer edge of the platform must accommodate the shortening of these extension bars. Although in this FIG., the access panel is open, the panel may also be in the closed position when retracting the platform.

FIG. 4 is another view from below the retracting platform, showing the platform in its fully retracted position.

FIG. 5 is a front perspective view of the platform in its extended position, with the access panel closed.

FIG. 6 is a cross-sectional side view of the extended platform, taken along the line 6-6 in FIG. 5.

FIG. 7 is a left side perspective view of the platform in its extended position.

FIG. 8 is a view from above the platform in its extended position.

FIG, 9 is a cross-sectional view of the joint assembly of the extension bar to the frame of the motor vehicle carrier truck, taken along the line 9-9 in FIG. 8.

FIG. 10 is a view from below the platform in its extended position.

FIG. 11 is an enlarged view of the joint assembly of the extension bars, platform support beam, and the hydraulics system, encircled in FIG. 10,

FIG. 12 is an enlarged view of the point of attachment of the distal ends of the support beam and the hydraulics piston.

### DRAWINGS—REFERENCE NUMERALS

10 Platform

12 Truck frame

14 Platform grate

16 Access panel

18 Railing system

20 Stanchions

22 Extension bar

24 Barrier means

26 Support beam

28 Hydraulics system

30 Hydraulics system piston

32 Elevation rod

34 Extension bar hinge

36 Hinge pin

38 Pivot block

40 Block pin

42 Support beam fins

44 Hydraulics piston tab

46 Fin-tab pin

### DESCRIPTION OF THE INVENTION

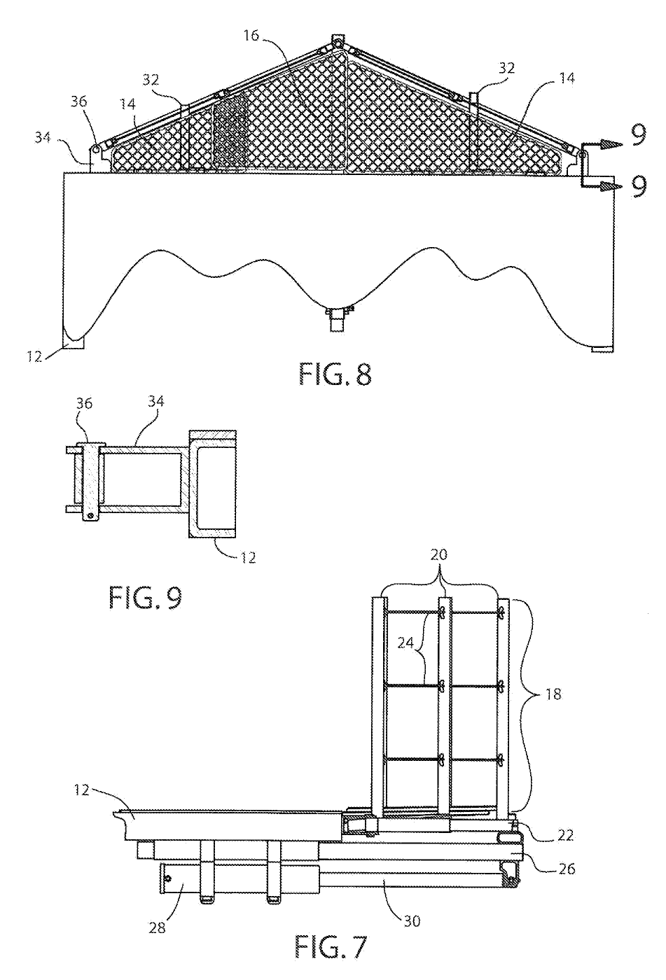

With reference now to the drawings, and in particular, FIGS. 1-12, for a new and improved retracting platform for motor vehicle carrier trucks, as generally designated by the reference numeral 10, the principles and concepts of the present invention will be described.

The present invention, the new and improved retracting platform, is comprised of a plurality of components. Such components, in their broadest context, include a platform grate, an access panel, a railing system, elevation rods, and a platform support beam, this beam having an attachment at its distal end to accommodate a power source, like a hydraulic system. Such components are individually configured and con-elated with respect to each other as to attain the desired objective.

A motor vehicle carrier truck, typical of those used in the industry, has a frame 12, as illustrated in FIG. 1. A truck's frame forms the supporting skeleton of the cargo-carrying portion of the carrier truck, and equipment such as lighting and hydraulics systems maybe anchored or fixed on the frame. The frame 12 may also be the outer edge of the decks or runners, upon which the cargo rests.

FIG. 1 shows the platform to be in its extended position. In this state, the platform grate 14, is substantially horizontal. The grate 14 must be sufficiently weight-bearing to support at least one adult, since it is expected that people would walk and stand on the grate 14. An access panel 16 is part of the grate 14. As will be discussed, the panel 16 provides a means of ingress to and egress from the platform 10, and should be lined up with a means of safely accessing the platform 10, such as a ladder or steps.

FIG. 1 also shows the railing system 18, which is comprised of a set of stanchions 20 attached to a telescoping extension bar 22, and a barrier means 24. The barrier means 24 can be achieved by using cables, as shown, or with other means, such as chains. The railing system 18 in the preferred embodiment is pivotally anchored on each end to the truck frame 12. It is recommended that, when positioning the stanchions 20 on the extension bar 22, that the stanchion 20 placement does not hinder the telescoping movement of the bar 22 in a manner that would preclude effective extension or retraction of the platform 10. In the same manner, the barrier means 24 must be of a sufficient length, since extension of the platform 10 increases the distance between stanchions 20.

In the preferred embodiment, a support beam 26 is centered underneath the platform 10, parallel to the direction of extension and retraction. This beam. 26 minimizes the platform's 10 weight upon the hydraulics system 28, which is not designed or positioned to withstand such forces. The top surface of the distal end of the beam 26 is attached to the extension bars 22, where they are pivotally joined together. The proximal end of the beam 26 is anchored to the frame 12 of the carrier truck. The bottom surface of the distal end of the beam 26 is attached to the piston 30 of the hydraulics system 28. The support beam 26 therefore must be strong enough to support the weight of the platform 10 and durable enough to withstand the forces exerted by the hydraulics system 30, yet the beam 26 must also have the ability extend and retract, a property which can be achieved if the beam 26 has telescoping capabilities.

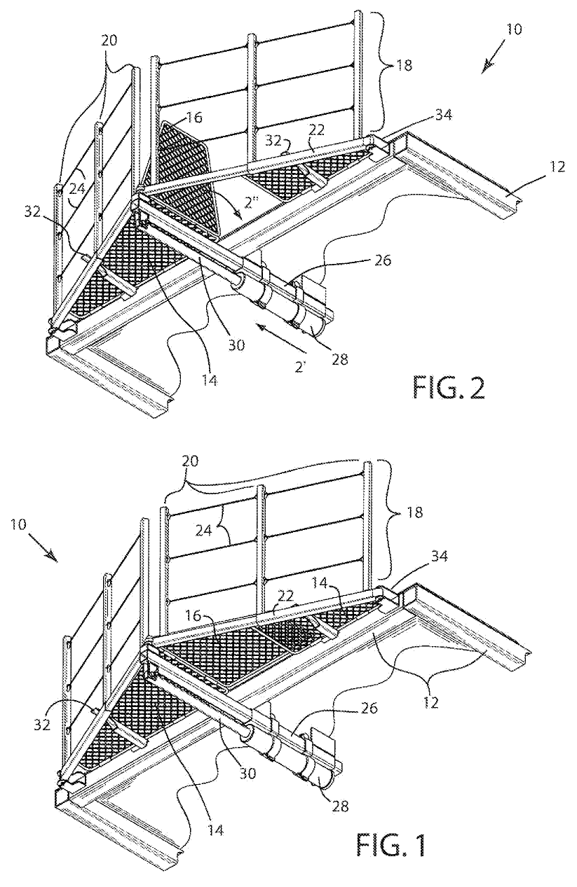

FIG. 2 shows the direction of extension of the platform 10, along the 2′ arrow. Extension is achieved by activating a power system, such as the hydraulics system 28 in the preferred embodiment, to push out the hydraulic piston 30. Because the support beam 26 is attached to both the piston 30 and the extension bars 22 of the railing system 18, when the piston 30 is pushed outwards, the entire platform 10 then extends outwards, while the bars 22 extend to their full length.

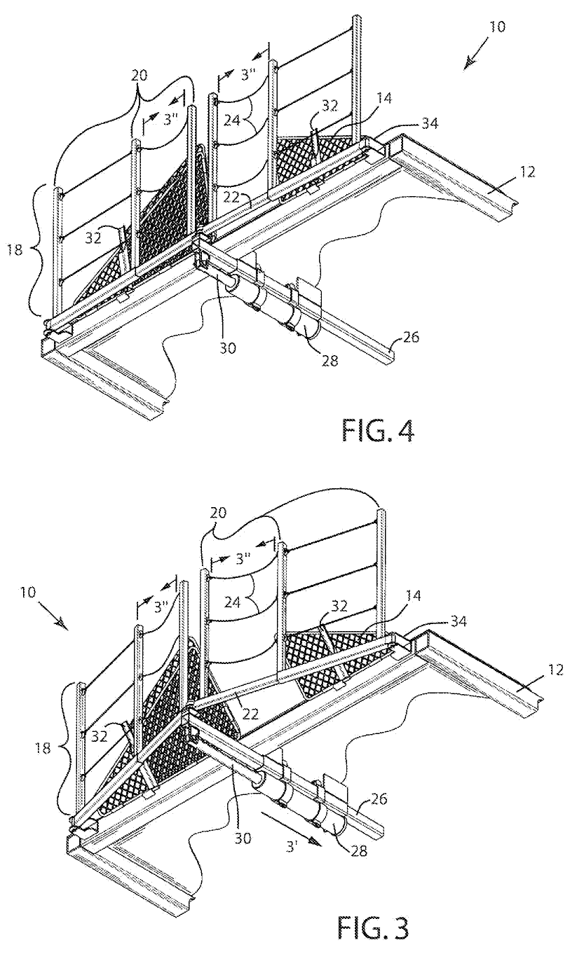

The platform 10 in mid-retraction is illustrated in FIG. 3. The platform 10 retracts along the direction indicated by the 3′ arrow. Retraction is achieved when the hydraulics system 28 is activated, pulling the piston 30 towards the carrier truck. Because the extension bars 22 are attached to the support beam 26, which in turn is attached to the piston 30, the point where the extension bars 22 are pivotally joined is pulled towards the carrier truck. As depicted by the 3″ arrows, the distance between some stanchions 20 decreases when the railing system 18 is retracted, as the extension bars 22 are adducted. It is thus necessary for the hairier means 24 to adapt to the shortening extension bars 22. When the platform 10 is fully retracted, the extension bars 22 are substantially parallel to the longitudinal frame 12 of the earner buck, and the grate 14 is in a substantially vertical position, as is the elevation rod 32 between the grate 14 and the bars 22, as illustrated in FIG. 4.

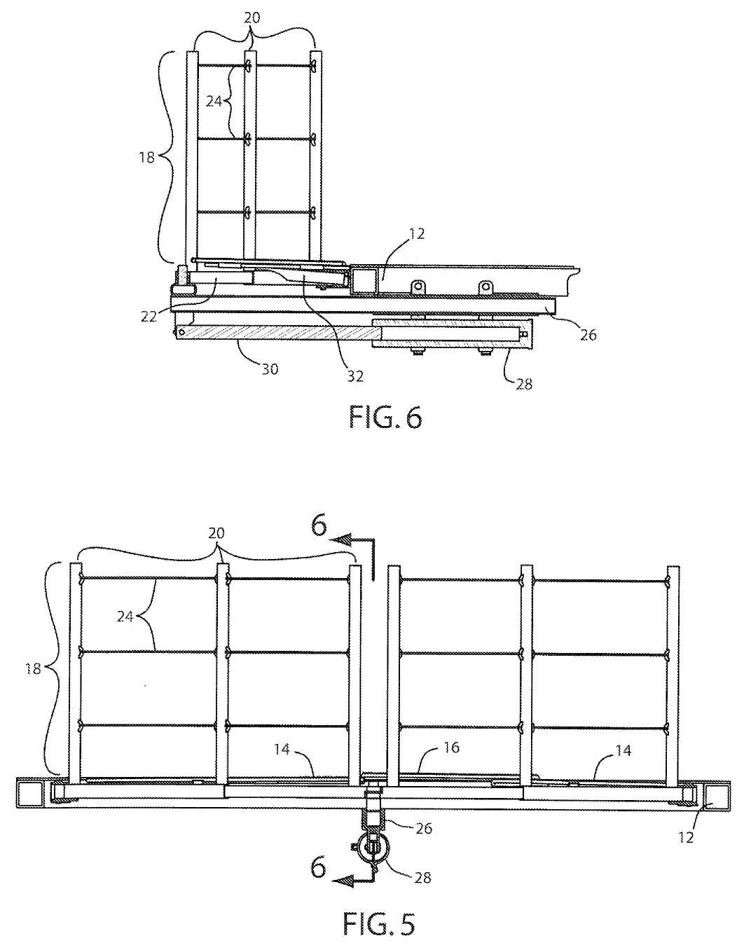

In the preferred embodiment, at least one elevation rod 32 is positioned perpendicular to the truck frame 12, and is pivotally joined to the frame 12 between an extension bar 22 and the platform grate 14. Upon retraction, when the extension bars 22 are drawn towards the carrier truck, the elevation rods 32 slide along the extension bars 22, concurrently lifting the platform grate 14 from a horizontal to a vertical position. Similarly, upon extension, when the bars 22 are pushed away from the carrier truck, the rods 32 slide along the bars 22, and the grate 14 is lowered. FIGS. 5, 6 and 7, considered together, illustrate these parts and their relationship with the mechanics of extension and retraction. The rods 32 therefore significantly reduce the friction between the bars 22 and the grate 14, which in turn reduces wear and tear on these parts, in the preferred embodiment, the elevation rod 32 is tapered at its distal end to promote a smooth transition of the grate 14 from vertical to horizontal positions.

While the support beam 26 does bear some of the weight of the platform 10, it is also important for the extension bar hinges 34 to do so as well. Although the hinges must be weight-bearing, they must also allow for relatively smooth pivoting of the extension bars 22 upon extension or retraction of the platform 10. In the preferred embodiment, the hinges 34 are anchored to the frame 12, and the pivoting mechanism can be as simple as a hinge pin 36 connecting the bar 22 to the hinge 34, as seen in FIGS. 8 and 9.

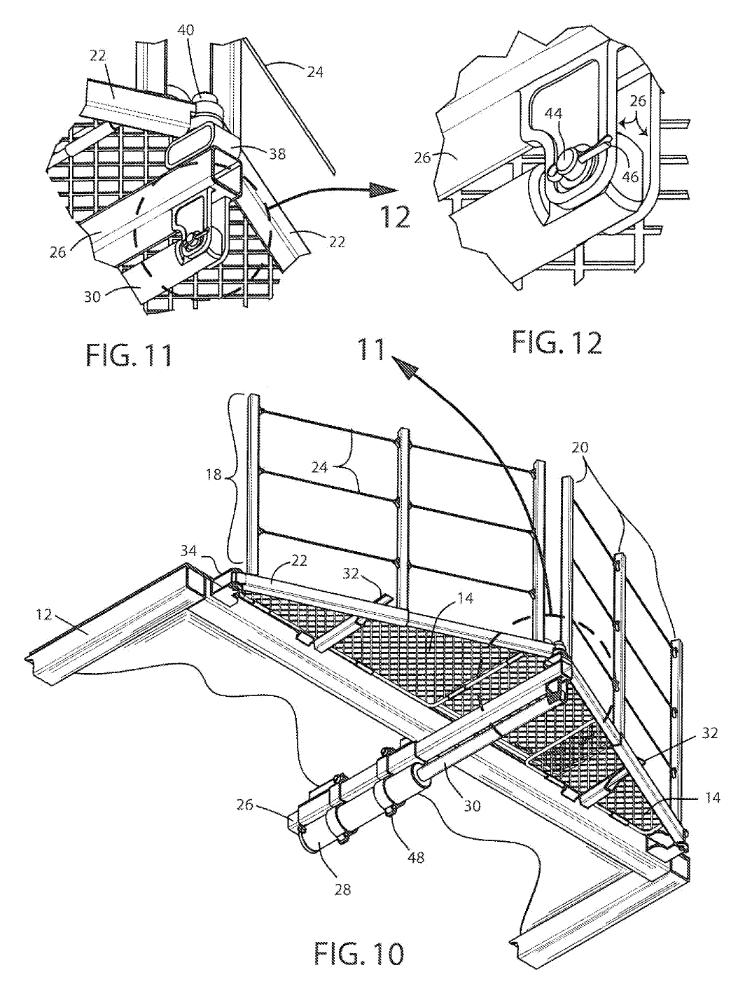

A similar pivoting joint assembly connects the extension bars 22 together. Considerable friction, force, and wear-and-tear is expected at that junction. The support beam 26, which bears the weight of the platform 10 and is the point of attachment of the hydraulics system 28 generating the forces to retract and expand the platform 10, should be protected from the forces of friction as much as possible. A pivot block 38 can reduce the friction caused by the pivoting extension bars 22 on the support beam 26. In the preferred embodiment, the pivot block 38 is a hollow bar anchored to the support beam 26, and is made of the same material as the support beam 26, but the pivot block 38 can be any material that is economical to replace, and be in any configuration that will allow the block 38 to withstand the forces of friction over repeated use. As seen in FIGS. 10 and 11, a block pin 40 joining the extension bars 22 to each other and to the block 38 allows for the pivotal joining of the bars.

Considerations for friction factors are not as critical where the support beam 26 connects to the piston 30 of the hydraulics system 28, because these elements move in the same plane in unison. To achieve a connection point that will withstand the forces exerted upon it, in the preferred embodiment, the distal end of the support beam 26 has a pair of ventral fins 42. In turn, the distal end of the hydraulics piston 30 has a pair of protruding tabs 44 that correspond with the fins 42. The tabs 44 protrude through the fins 42, and a fin-tab pin 42 secures the connection, as illustrated in FIG. 12.

The hydraulically powered beam system combines the weight-bearing strength of the support beam 26, and the kinetic energy necessary to extend and retract the platform 10. In spite of the advantage of this combination, positionally secured together and anchored to the truck frame 12 with a series of straps 48, it is noteworthy that the support beam 26 can be coupled with any means to power the adduction and abduction of the support beam, such as battery-, electricity-, or gasoline-powered mechanisms. However, the hydraulics system 28 is the preferred source of power, because most carrier tracks are already equipped with a hydraulics system to change the configuration of the truck as needed, in conformity with the cargo load. As such, the carrier truck's existing hydraulics system can be easily adapted to accommodate a retracting platform such as the one described.

As to the manner and usage of the present invention, the same should be apparent from the above description.

With respect to the above description, it is to be realized that, to achieve the optimum relationships for the parts, consideration must be made to variations in size and dimension, materials, shape, form, function, and the manner of operation, assembly, and use. Such considerations are intended to be encompassed by the present invention, and will be readily apparent and obvious to one skilled in the art. All suitable modifications, adaptations, and equivalents may be resorted to, falling within the scope of the invention. Although one embodiment has been illustrated in the accompanying drawings and described in the foregoing detailed description, it will be understood that the intention is not limited to the embodiment discussed, but is capable of numerous rearrangements, modifications, and substitutions without departing from the spirit and scope of the invention. Other changes, and uses within the scope of the invention, as defined by the appended claims, will suggest themselves to those versed in the art. This application is intended to cover such departures from the present disclosure as those falling within known or customary practice in the art to which this invention pertains, and which fells within the limits of the appended claims.

It will be noted that this invention fully meets the objectives set forth.

The invention claimed is:

1. A retractable platform for trucks, comprising:
a. a platform grate pivotally attached to the truck frame, permitting the transition of the grate from an extended, substantially horizontal position to a retracted, substantially vertical position;
b. a railing system that conforms its length to accommodate the distal edge of the grate when extended or the proximal edge of the grate when retracted;
c. elevation rods hingedly attached and arranged perpendicular to the truck frame, said rods positioned between the platform grate and the railing system to assist in the transition between the grate's positions;
d. an extending support beam strong enough to support the weight of the platform; and
e. a power source to effectively power to push out and pull in the railing system.

2. A retractable platform as recited in claim 1, wherein an access panel is hingedly attached on one edge to the grate, to permit an individual to pass through the grate when said access panel is in the open position, or to support an individual standing upon said access panel in the closed position.

3. A retractable platform as recited in claim 1, wherein said railing system comprises:
a. extension bars which are pivotally attached to each other at one end and pivotally attached to the truck frame at the other end, said extension bars conforming their length to the distal edge of the extended grate, and the proximal edge of the retracted grate;
b. vertical stanchions anchored to the extension bars, the placement of such stanchions arranged so as not to impede the extension and retraction of the extension bars; and
c. barrier means connecting adjacent stanchions, arranged in a manner that would prevent an individual from falling through or over the railing system, the length of said barrier means such as not to impede the extension and retraction of the extension bars.

4. A retractable platform as recited in claim 1, wherein said elevation rods are tapered at its distal ends In such a manner as would promote the grate's smooth transition between positions, while allowing the grate to reach a substantially horizontal position.

5. A retractable platform as recited in claim 1, wherein the proximal end of the support beam is fixed to the frame, while the distal end of the beam is fixed to the railing system and to the distal end of the power source in such a manner that the beam will extend and retract the railing system when the power source is engaged.

6. A retractable platform as recited in claim 1, wherein the proximal end of the support beam is fixed to the frame, while the railing system is attached to a pivot block anchored at the distal end of the support beam, the distal end of the beam also fixed to the distal end of the power source in such a manner that the beam will extend and retract the railing system when the power source is engaged.

7. A retractable platform as recited in claim 1, wherein the power source is a hydraulics system.

8. A retractable platform as recited in claim 3, wherein said extension bars extend and retract by means of a telescoping action.

9. A retractable platform as recited in claim 3, wherein chains, cables, wire, rope, or telescoping bars are used as the barrier means.
